(19) United States
(12) Patent Application Publication
(10) Pub. No.: US 2008/0046600 A1
(43) Pub. Date: Feb. 21, 2008

(54) TRANSMISSION METHOD

(75) Inventors: Jing Shun Lin, Yilan County (TW); Keng Ming Su, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/770,627

(22) Filed: Jun. 28, 2007

(30) Foreign Application Priority Data
Jun. 28, 2006 (TW) TW95123313

(51) Int. Cl. G06F 3/00

(52) U.S. Cl. 710/1

(57) ABSTRACT

A transmission method for a multimedia device having a capture function. The transmission method comprises outputting device information to an external device; receiving acknowledgement information; determining whether the external device supports a specific technology according to the acknowledgement information; detecting a plurality of functions of the external device when the external device supports the acknowledgement information; activating one of functions; and providing processing information to the external device for executing the activated function.

### BACKGROUND OF THE INVENTION

1. Field of the Invention

The invention relates to a transmission method, and more particularly to a transmission method for transmitting data between peripherals.

2. Description of the Related Art

FIG. 1 is a control schematic diagram of a plurality of conventional peripherals. A computer 12 controls the peripherals. The structure of FIG. 1 is a topology structure. Computer 12 is a main device and peripheral group 14 is a slave device.

Peripheral group 14 comprises various peripherals, such as a Digital Still Camera (DSC) 141, a Personal Digital Assistant (PDA) 142, a Digital Video (DV) 143, a printer 144, and a recorder 145. Each peripheral within in peripheral group 14 utilizes computer 12 to communicate with other peripherals within in peripheral group 14.

For example, a user desires to take image data stored in DV 13 and record the image data on a Digital Versatile Disc (DVD). First, computer 12 downloads the image data stored in DV 13. Next, recorder 145 controlled by computer 12 takes and records the downloaded image data on the DVD.

One peripheral transmits information to another peripheral through computer 12 such that the processing time is increased. With technology development, the performance of peripherals is increased. The peripheral comprises the On The Go (OTG) function such that the peripheral can serve not only a slave device, but also as a main device.

The structure of the peripheral having the OTG function is similar to a Point To Point (PTP) IEEE 1394 structure. FIGS. 2A˜2C are schematic diagrams of peripherals having OTG functionality.

As shown in FIG. 2A, since DSC 141_{OTG} and printer 144_{OTG} have OTG functions, DSC 141_{OTG} directly transmits a state image to printer 144_{OTG} through a connection line 22 such that the state image is printed by printer 144_{OTG}.

As shown in FIG. 2B, since PDA 142_{OTG} has OTG functionality, PDA 142_{OTG} directly transmits image data to printer 144_{OTG} through the connection line 22 such that the image data is printed by printer 144_{OTG}.

As shown in FIG. 2C, since DV 143_{OTG} and recorder 145_{OTG} have OTG functionality, DV 143_{OTG} directly transmits image data to recorder 145_{OTG} through the connection line 22 such that the image data is recorded by recorder 145_{OTG}.

The peripheral having OTG function stores various driving processes for controlling various peripherals. For example, to receive image data output from DSC 141_{OTG} and PDA 142_{OTG}, printer 144_{OTG} is required to store diving processes, brands, types of DSC and PDA. Thus, the peripheral having OTG functionality requires memory high capacity such that cost and processing time are increased.

### BRIEF SUMMARY OF THE INVENTION

Transmission methods are provided. An exemplary embodiment of a transmission method for a multimedia device having a capture function comprises outputting device information to an external device; receiving acknowledgement information; determining whether the external device supports a specific technology according to the acknowledgement information; detecting a plurality of functions of the external device when the external device supports the acknowledgement information; activating one of the functions; and providing processing information to the external device for executing the activated function.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a control schematic diagram of conventional peripherals;

FIGS. 2A˜2C are schematic diagrams of peripherals having OTG functionality;

FIG. 3 is a connection schematic diagram of an exemplary embodiment of a DV and a recorder; and

FIGS. 4a and 4b are flowcharts of an exemplary embodiment of the transmission method.

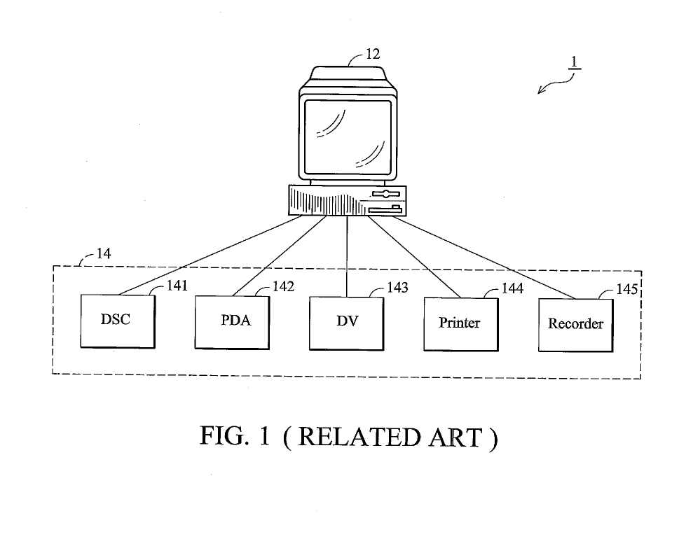

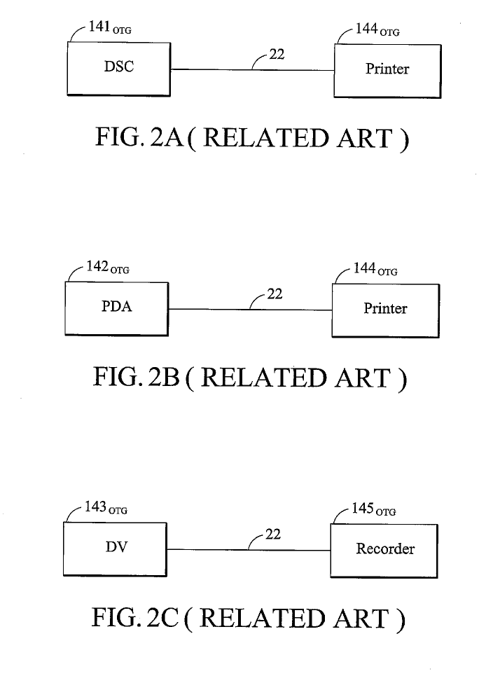

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A transmission method of the invention is applied between two peripherals. One peripheral is a multimedia device having a capture function, such as DSC or DV. For clarity, a DV and a recorder are given as an example.

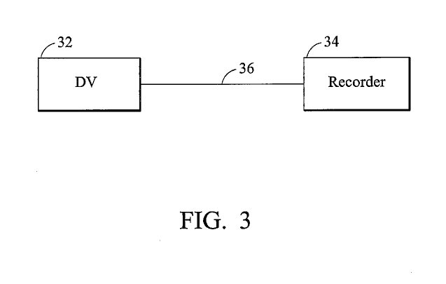

FIG. 3 is a connection schematic diagram of an exemplary embodiment of a DV and a recorder. DV 32 is coupled to recorder 34 through a connection line 36, such as a Universal Serial Bus (USB). Since DV 32 controls the operation of recorder 34, DV 32 is a main device and recorder 34 is a slave device.

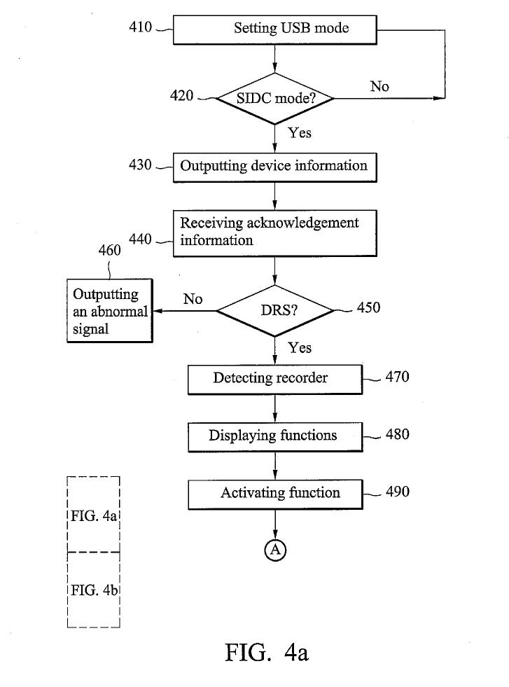

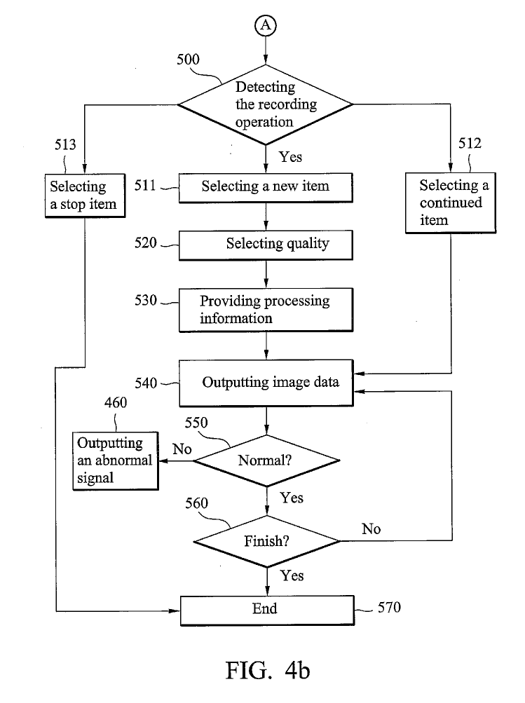

FIGS. 4a and 4b are flowcharts of an exemplary embodiment of the transmission method. With reference to FIG. 3, assume that the connection line 36 is a USB line. When the USB line connects DV 32 and recorder 34, DV 32 is set to USB mode, in step 410.

DV 32 detects USB mode in step 420. When USB mode of DV 32 does not set to SIDC mode, DV 32 is set to USB mode in step 410. When USB mode of DV 32 is set to SIDC mode, DV 32 outputs device information to recorder 34 in step 430. The device information comprises a brand, a type or a parameter of recorder 34. The parameter represents that recorder 34 supports a specific technology.

When receiving the device information, recorder 34 outputs acknowledgement information to DV 32 in step 440. DV 32 determines whether recorder 34 supports the specific technology according to a specific bit of the acknowledgement information in step 450.

In this embodiment, a recorder is given as an example and the transmission method is referred to as the Direct Recording Standard (DRS). To transmit information, DV 32 and recorder 34 must support DRS.

If recorder 34 does not support the specific technology, DV 32 outputs an abnormal signal, in step 460 notify a user that the recording operation has not been executed. Additionally, if DV 32 does not receive the acknowledgement information, DV 32 also outputs the abnormal signal.

When recorder 34 supports the specific technology, DV 32 starts to detect functions of recorder 34 in step 470. In this step, the brand, the type, and functions of recorder 34 are detected by DV 32. The detected functions of recorder 34 are displaying in a display panel of DV 32 in step 480. A user selects one of the displayed functions in step 490. In this embodiment, the displayed functions comprise a recording operation and an editing operation

If the user selects the recording operation, DV 32 detects the previous state in step 500. When recorder 34 executes the recording operation and the user interrupts the recording operation, DV 32 stores the interrupted recording operation. Thus, the display panel of DV 32 displays a continue item for continuing the unfinished recording operation when the user selects the recording operation again.

When no unfinished recording operation is stared in DV 32, the display panel of DV 32 displays a new item for executing a new recording operation. Additionally, the display panel displays a stop item for interrupting the recording operation.

When the user selects the new item in step 511, DV 32 provides processing information to recorder 34. The processing information comprises image data and specification data. The specification data comprises size of the image data, an access path or quality.

The display panel of DV 32 displays quality items in step 520 for selecting the quality of the recording function. The quality items comprise a High Quality (HQ), a Super High Quality (SHQ) and a Low Quality (LQ).

DV 32 provides the processing information comprising the size of the image data, an access path, and other information to recorder 34 in step 530. DV 32 outputs image data to recorder 34 in step 540. When recorder 34 starts to record, DV 32 detects the recording operation in step 550.

When the recording operation is abnormal, such as when the USB line is not connected to DV 32 and recorder 34, DV 32 interrupts the recording operation and outputs an abnormal signal to notify the user in step 460. If the recording operation is normal, DV 32 detects whether to the recording operation finish in step 560.

When the recording operation is finished, the recoding operation is stopped in step 512. If the recording operation is unfinished, DV 32 continuously outputs image data to recorder 34 in step 540.

Additionally, if the continue item is selected in step 512, DV 32 starts to provide image data to recorder 34 in step 540 for continuing the recording operation.

When the user does not desire to continuously execute the unfinished recording operation, the stop item is selected in step 513 for stopping the recoding operation in step 570.

As discussed above, the transmission method of the invention allows data to be transmitted between two peripherals. Thus, transmission time is reduced. Additionally, the peripheral utilizing the transmission method of the invention is not required to store addition driving processes of other peripherals, thus, cost is reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transmission method for a multimedia device having a capture function, comprising:
outputting device information to an external device;
receiving acknowledgement information;
determining whether the external device supports a specific technology according to the acknowledgement information;
detecting a plurality of functions of the external device when the external device supports the acknowledgement information;
activating one of functions; and
providing processing information to the external device for executing the activated function.

2. The transmission method as claimed in claim 1, wherein the device information comprises the brand, the type or a parameter of the multimedia device.

3. The transmission method as claimed in claim 2, wherein the parameter represents that the multimedia device supports the acknowledgement information.

4. The transmission method as claimed in claim 1, further comprising outputting an abnormal signal when the multimedia device can not receive the acknowledgement information.

5. The transmission method as claimed in claim 1, wherein the multimedia device provides an abnormal signal when the external device does not support the specific technology.

6. The transmission method as claimed in claim 1, further comprising displaying the device information.

7. The transmission method as claimed in claim 1, wherein the processing information comprises image data.

8. The transmission method as claimed in claim 7, wherein the processing information further comprises specification data.

9. The transmission method as claimed in claim 8, wherein the specification data comprises the size of the image data.

10. The transmission method as claimed in claim 1, further comprising outputting an abnormal signal when the external device executes the activated function and an abnormal event occurs in the external device.

11. The transmission method as claimed in claim 1, wherein the multimedia device is coupled to the external device utilizing a Universal Serial Bus (USB).

12. The transmission method as claimed in claim 10, further comprising setting the USB in SIDC mode.
